(19) United States
(12) Patent Application Publication
(10) Pub. No.: US 2010/0208927 A1
(43) Pub. Date: Aug. 19, 2010

(54) MICROPHONE MODULE FOR A HEARING DEVICE

(76) Inventors: Hartmut Ritter, Neunkirchen am Brand (DE); Michael Sattler, Bubenreuth (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/706,925

(22) Filed: Feb. 17, 2010

(30) Foreign Application Priority Data
Feb. 17, 2009 (DE) 10 2009 009 274.9

(51) Int. Cl. H04R 25/00

(52) U.S. Cl. 381/324

(57) ABSTRACT

A better decoupling of the microphones of a hearing device from the housing of the hearing device is achieved by a microphone module having a module housing that is not part of the housing of the hearing device, and at least one microphone including a microphone housing that is arranged in the module housing. Furthermore, the microphone module has a mounting device that elastically supports the module housing in the housing of the hearing device. The microphone module can additionally have an inductive receiver, for example, and/or can be connected with a flexible circuit board to the remaining electronics of the hearing aid or the hearing device.

### BACKGROUND OF THE INVENTION

1. Field of the Invention

The present invention concerns a microphone module for a hearing device. As used herein, a hearing device means any sound-outputting device (in particular a hearing aid, a headset, headphones and the like) that can be worn in or on the ear or on the head.

2. Description of the Prior Art

Hearing aids are wearable hearing devices that serve to assist the hard of hearing. In order to accommodate numerous individual needs, different structural shapes of hearing devices are provided, such as behind-the-ear hearing devices (BtE), hearing devices with external earpiece (RIC: receiver in the canal) and in-the-ear hearing devices (ItE), as well as concha hearing devices or canal hearing devices, for example (ITE, CIC). The hearing devices listed as examples are worn on the outer ear or in the auditory canal. Moreover, however, bone conduction hearing devices, implantable or vibro-tactile hearing devices are available on the market. The stimulation of the damaged hearing thereby ensues either mechanically or electrically.

Hearing aids have the basic components of an input transducer, an amplifier and an output transducer. The input transducer is normally a sound receiver (for example a microphone) and/or an electromagnetic receiver (for example an induction coil). The output transducer is most often realized as an electroacoustic transducer (for example miniature speaker) or as an electromechanical transducer (for example bone conduction earpiece). The amplifier is typically integrated into a signal processing unit. This basic design is shown in FIG. 1 in the example of a behind-the-ear hearing aid. One or more microphones 2 to receive the sound from the environment are installed in a hearing device housing 1 to be worn behind the ear. A signal processing unit 3 that is likewise integrated into the hearing aid housing 1 processes the microphone signals and amplifies them. The output signal of the signal processing unit 3 is transferred to a speaker or earpiece 4 that outputs an acoustic signal. The sound may be transmitted to the eardrum of the device wearer via a sound tube that is fixed in the auditory canal with an otoplastic. The power supply of the hearing aid, and in particular that of the signal processing unit 3, ensues via a battery 5 that is likewise integrated into the hearing aid housing 1.

Since amplifications of 80 dB and more are required in certain hearing devices, the structure-borne sound and feedback suppression at the microphones is one of the main problems in satisfying these high demands. In principle, the transfer of that structure-borne sound directly from an earpiece installed in the hearing device housing to the microphone or, respectively, microphones that are likewise integrated into the hearing device housing should be avoided. If such feedback is too high, either the amplification must be reduced or appropriate damping measures must be provided.

Conventional, damping measures have most often been only to enclose and support the microphones in a resilient receptacle. The microphones supported in this way are clamped against the housing and/or its internal module support (frame) by an interference fit. Only a slight damping of the structure-borne sound is achieved by such a mounting of the microphones.

### SUMMARY OF THE INVENTION

An object of the present invention is to better damp the structure-borne sound in hearing devices with high amplification.

According to the invention, the above object is achieved by a microphone module for a hearing device that has a module housing that is not part of the housing of the hearing device, a microphone including a microphone housing that is located in the module housing, an inductive receiver located in the module housing, and a mounting device that elastically (resiliently) supports the module housing in the housing of the hearing device. A receiver module decoupled from the housing of the hearing device thereby results. For example, the mass of the module can be altered by the additional receiver so that the coupling between the module and the hearing device housing can be varied.

Through the module housing, the microphone advantageously can be additionally decoupled from the housing of the hearing device. High amplifications can thus be employed with little danger of feedback.

An additional microphone with its own microphone housing is advantageously accommodated in the module housing. The same high-quality decoupling thereby ensues for both microphones.

The microphone furthermore can be contacted with a flexible circuit board that is lead out of the module housing. This is an alternative to individual cords that are directed out of the module having and entails advantages in the assembly.

According to a further embodiment, the module housing is hermetically sealed, other than from respective sound inlet openings for each microphone. This is in particular advantageous if the microphone module is installed in a hearing aid or another hearing device and, due to the seal, no sound penetrates into the internal components of the module housing and to the microphones via unintentional paths.

In a further embodiment, the microphone housing can be mounted in the module housing with a structurally supported sound-damping microphone pouch. Such a microphone pouch decouples the microphone housing and the microphone from the module housing with regard to the transmission of structure-borne sound.

In particular, the microphone pouch can have a sound conduction nozzle (connector) in order to conduct sound from a sound inlet opening of the module housing to an opening in the microphone housing. Such a sound inlet nozzle can provide advantages by transmitting the sound optimally undisturbed to the respective microphone.

Furthermore, the mounting device can have multiple rubber nubs that can be plugged into or onto the housing of the hearing device. A robust and installation-friendly mounting (support) of the microphone module can be achieved in this way.

The microphone module can be particularly advantageously used in a hearing device that is fashioned as a hearing aid. The danger of feedback is markedly reduced by a microphone module of this design in a hearing device.

### BRIEF DESCRIPTION OF THE DRAWINGS

FIG. 1 shows the basic design of a hearing device according to the prior art.

FIG. 2 is a cross section through a microphone module according to the invention.

FIG. 3 is a plan view of the microphone module of FIG. 2.

FIG. 4 is a view of the microphone module from FIG. 2 with the cover removed, and connected circuit board.

FIG. 5 shows the microphone module of FIG. 2 in the state in which it is installed in a hearing device.

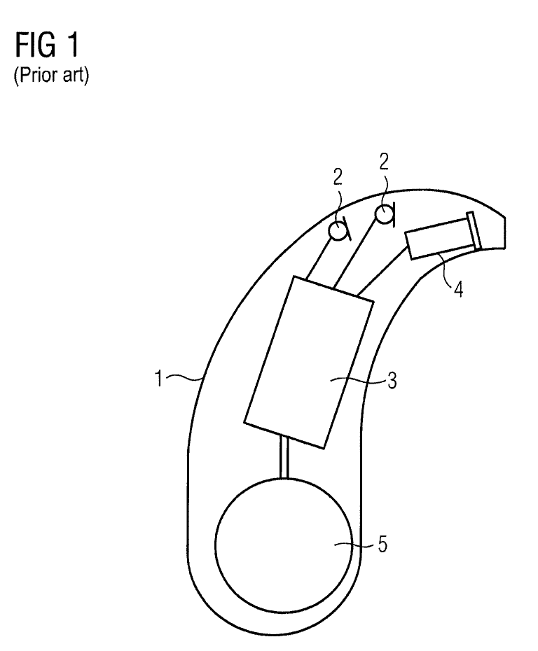

### DESCRIPTION OF THE PREFERRED EMBODIMENTS

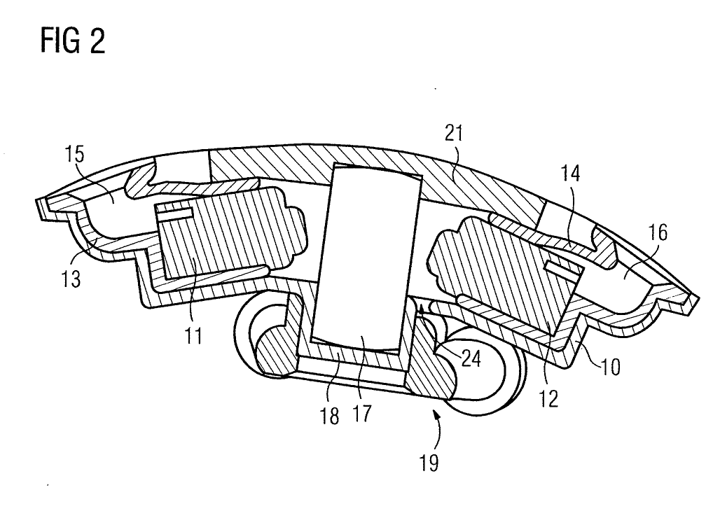

The microphone module shown in FIG. 2 represents a separate (stand-alone) unit that can be easily installed in a hearing device housing or can be easily removed from the hearing device housing. It has a stand-alone module housing 10 in which here are accommodated two microphones 11, 12. The microphones 11, 12 are mounted (carried) in the module housing 10 by microphone pouches 13, 14. The module pouches 13, 14 respectively have a sound conduction nozzles 15, 16. The sound to be received penetrates from the outside to the microphones 11, 12 via these sound conduction nozzles 15, 16. To damp structure-borne sound, the microphone pouches 13, 14 are produced from a soft material, for example rubber or foamed rubber. The housing of the microphones 11, 12 does not directly contact the module housing 10. Structure-borne thus sound can only arrive from the module housing 10 to the microphone housings or the microphones 11, 12 via the microphone pouches 13, 14.

Furthermore, an inductive receiver 17 is arranged in the module housing 10, here between the microphones 11 and 12. It is only optionally contained in the microphone module. This can entail advantages with regard to the wiring because the inductive receiver 17, like the microphones 11, 12, represents an input transducer whose signals are to be transferred to an amplifier.

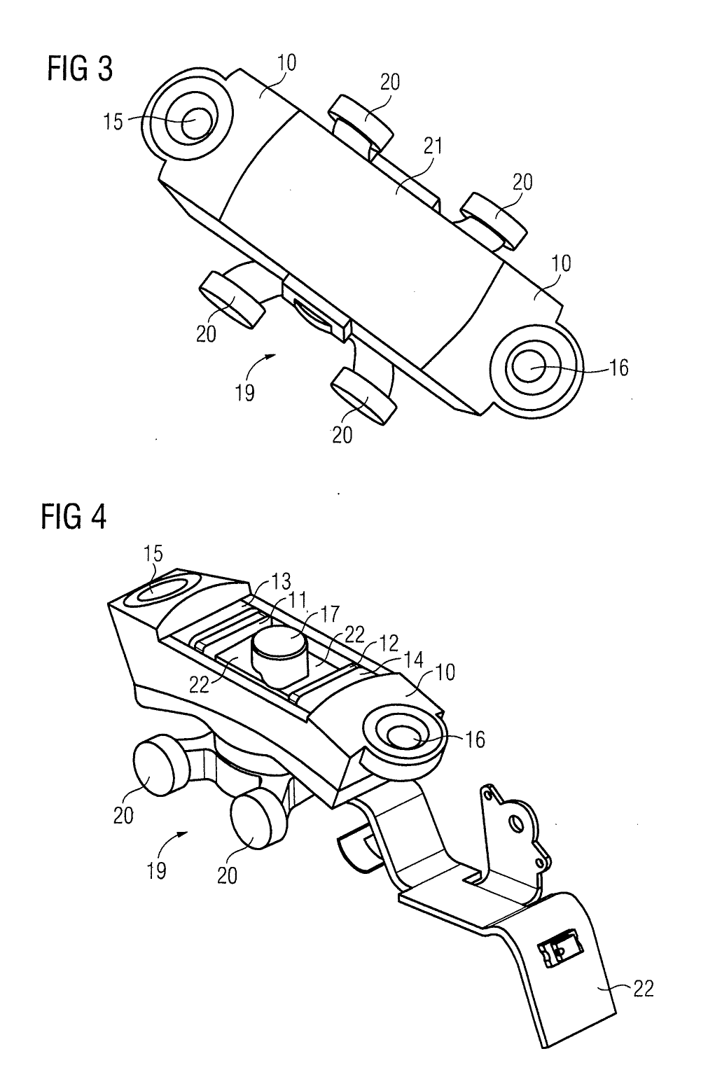

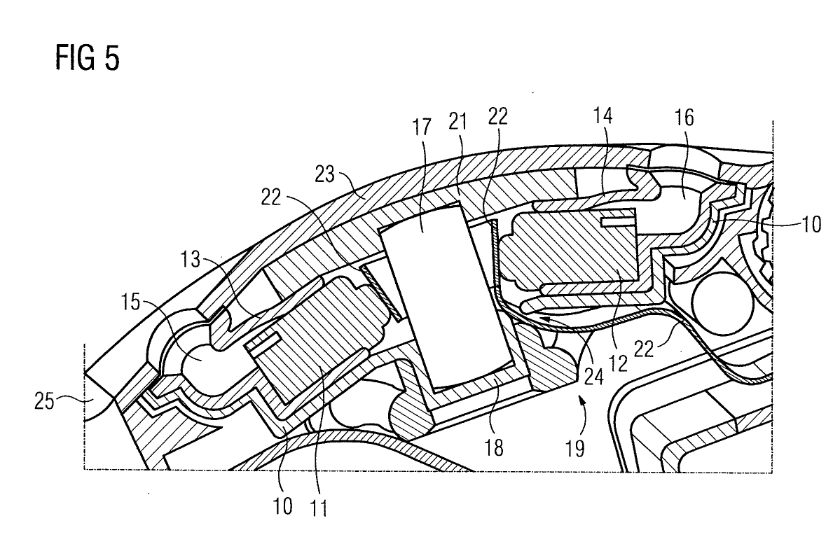

Furthermore, the module housing 10 has a base 18 onto which a rubber bearing element 19 is placed from the outside. This rubber bearing element 19 is better recognizable in FIGS. 3 and 4. Here it has four nubs 20 that stick out in pairs to the side. They can be inserted into corresponding mounts of a hearing device housing (not shown).

According to FIG. 2, a cover 21 that seals the module housing 10 at the top or from the outside is provided on the top side, i.e. that side that points outward in the state as it is inserted into the hearing device. The cover 21 here simultaneously serves to fix the inductive receiver 17.

The microphone module is shown from its top side in FIG. 3, i.e. the side pointing outward. In addition to the rubber bearing element 19 with its laterally protruding nubs 20 that was already mentioned, the longitudinal shape of the microphone module is recognizable at whose ends the microphone inlets with the sound conduction nozzles 15, 16 are respectively arranged. The cover 21 extends into the middle region of the module housing 10.

FIG. 4 shows an angled view of the microphone module, wherein the cover 21 is removed. In addition to the elements already explained in connection with FIGS. 2 and 3, a flexible circuit board 22 which reaches into the inside of the microphone module up to the microphones 11, 12 and contacts these is seen in FIG. 4.

The microphone module is shown installed into the hearing device in FIG. 5. The Figure shows a section both through the microphone module and through the corresponding part of the hearing device. In this depiction, not only the components already mentioned in connection with FIG. 2 but also a covering 23 on the top side are shown. Moreover, FIG. 5 shows the flexible circuit board 22 that is directed through a gap 24 in the module housing 10. A portion of the circuit board 22 contacts the left microphone 11 and an additional portion of said flexible circuit board 22 contacts the right microphone 12. In that the circuit board 22 is flexible, in practice hardly any structure-borne sound can be transmitted from the hearing device housing or a component located therein to the microphone module or, respectively, the microphones 11, 12.

In this example, the microphone module according to the invention integrates the two microphones 11, 12 (necessary for a directional effect) as well as an auditory coil into an independent unit that is completely separate from the hearing device housing 25 and is decoupled from this by an elastic bearing. The sealing of the microphones 11, 12 within this module is—as explained above—achieved conventionally by microphone pouches 13, 14 with or without corresponding sound conduction nozzles 15, 16. The better decoupling of the microphones from the hearing device housing or its internal module support (frame) is to be mentioned as a particular advantage of the microphone module according to the invention. Furthermore, a hermetic sealing from the internal hearing device space can be achieved. This has the result that the interference noise from the earpiece can be better suppressed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A microphone module for a hearing device, said microphone module comprising:
a stand-alone module housing;
a microphone, having a microphone housing, contained in said module housing;
an inductive receiver contained in said module housing; and
a mounting structure at an exterior of said module housing, said mounting structure being at least partially comprised of resilient material and having a structural configuration that is shaped and dimensioned to resiliently mount and support said module housing in a housing of a hearing device.

2. A microphone module as claimed in claim 1 wherein said microphone is a first microphone and said microphone housing is a first microphone housing, and comprising a second microphone, having a second microphone housing, contained in said module housing.

3. A microphone module as claimed in claim 1 comprising a flexible circuit board having a first circuit board portion contained in said module housing, to which said microphone is electrically connected, and having a second circuit board portion, continuous with said first circuit board portion, which extends outside of said module housing.

4. A microphone module as claimed in claim 1 wherein said module housing has a sound inlet opening therein for admitting sound to said microphone, said module housing being otherwise hermetically sealed.

5. A microphone module as claimed in claim 1 comprising a microphone pouch inside of and supported by said module housing, said microphone pouch being comprised of sound-damping material and said microphone being contained in said microphone pouch in said module housing.

6. A microphone module as claimed in claim 5 wherein said module housing has a sound inlet opening therein for admitting sound to said microphone, and wherein said microphone pouch comprises a sound conduction nozzle having an open interior that communicates said microphone with said sound inlet opening.

7. A microphone module as claimed in claim 1 wherein said mounting device comprises a plurality of rubber nubs configured to be plugged into or onto the housing of the hearing device.

8. A hearing device comprising:
a hearing device housing configured to be worn at an ear of a person;
a microphone module comprising a stand-alone module housing, a microphone, having a microphone housing, contained in said module housing, an inductive receiver contained in said module housing, and a mounting structure at an exterior of said module housing, said mounting structure being at least partially comprised of resilient material and having a structural configuration that is shaped and dimensioned to resiliently mount and support said module housing in said hearing device housing;
processing circuitry contained in said hearing device housing and electrically connected to said microphone and to said inductive receiver to receive respective electrical signals therefrom, said processing circuitry processing said electrical signals to generate a processing circuitry output; and
an output transducer in said hearing device housing, electrically connected to said processing circuitry to receive said processing circuitry output therefrom, said output transducer converting said processing circuitry output into a transducer output signal, and emitting said transducer output signal from said hearing device housing.

9. A hearing device as claimed in claim 8 wherein said hearing device housing is configured as a hearing aid housing.
